(19) United States
(12) Patent Application Publication
(10) Pub. No.: US 2010/0005769 A1
(43) Pub. Date: Jan. 14, 2010

(54) LAWN MOWER ATTACHMENT

(76) Inventor: Chris Landry, Palmetto, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/299,803

(22) PCT Filed: May 31, 2007
(86) PCT No.: PCT/US07/13078

§ 371 Date: Feb. 13, 2009

Related U.S. Application Data
(60) Provisional application No. 60/810,775, filed on Jun. 2, 2006.

(51) Int. Cl. A01D 34/00

(52) U.S. Cl. 56/13.6; 56/16.9

(57) ABSTRACT

A lawn mower assembly for attachment to a carrier vehicle, preferably a tractor, is described herein. The attachment has at least one electrical motor, preferably AC, with a cutting blade preferably mechanically attached to the rotor of the motor. When energized, the motor rotates, thus rotating the cutting blade. An electrical power generator is situated upon a platform also attached to the carrier vehicle. The assemblies are then attached to the deck. More than one assembly may be attached to the deck to provide for a larger cutting area. Each assembly may have more than one electrical motor/cutting blade combination. The assemblies may either be. removed or positioned upright for storage or when not in use.

### CROSS-REFERENCE TO RELATED APPLICATIONS

This application claims priority to U.S. Provisional Application No. 60/810,775 filed Jun. 2, 2006. The complete disclosure of this prior application is hereby incorporated herein by reference in its entirety for all purposes.

### BACKGROUND

Many conventional lawn mowers depend on power from motors that are used to drive the carrier vehicle. As such, one motor is typically used to provide power to the carrier vehicle as well as power to the lawn mower blades. Such combined systems typically rely on an indirect drive system from the motor, e.g. belt-pulley system. In such combined systems, any input that affects one system affects the output of the other. For example, if the lawn mower is a tractor with a lawn mower attached, if the tractor is going uphill, the power available to the blades may be diminished based upon the available total power to the system. If there is not enough excess power, the blades may slow down, thereby reducing the cutting effectiveness.

Further, because of mechanical limitations of belt-driving systems, the cutting area is typically limited for the average consumer. In a conventional system, to increase the cutting area, the number of blades is typically increased, from one directly under the carrier to two or more situated a distance from the center so that the circumference of the two or more blades creates a cutting swath of increased distance. As the cutting area increases, the distance of the blades from the carrier increases. This translates into longer belts necessary to drive the blades. As belts increase in length, the necessary size of the belt may increase as well as the number of intermediate pulleys to span the distance may increase. This not only increases cost, but also may reduce the stability and efficiency of the belts.

In addition, there may be a significant number of people that own external power generators that are under utilized. A person may purchase a power generator if, among various reasons, there exists an unacceptable possibility that due to a power outage, the purchaser may be without power for a period of time. The probability of power going out in most areas is small. Therefore, the external power generator typically may be used once or twice a year.

### SUMMARY

A lawn mower blade assembly is provided that allows the user to mow variably large areas of greenery while reducing the reliance upon belts. In an exemplary and non-limiting example, the lawn mower blade assembly is attached to tractor acting as the carrier via a trailer-hitch unit with the blade assembly on a movable platform, the blade assembly having a greenery cutting blade mechanically attached to an A/C electrical motor, and an A/C generator attached to the tractor to provide the A/C power to turn the A/C electrical motor, and in turn, the blades. In an exemplary and non-limiting example, there may be three blade assemblies attached to the tractor.

Some advantages may be realized through the use of an A/C powered electrical motor receiving power from a mobile electrical generator. A typical A/C motor will consume various levels of power depending upon the mechanical load. As the mechanical load increases, the motor draws more electrical power to attempt to maintain a constant speed. Thus, the rotational speed of the cutting blades may remain constant as long as the electrical system can handle the increased electrical capacity.

Additionally, in belt-driven systems where a central, rotating shaft imparts rotational motion on pulleys connected to belts, as the desired cutting width increases, the length of belts, and/or number of pulleys increases. This greatly increases the cost as long belts must be designed for stability along long lengths of travel and increases friction and heat losses. The width of the cutting area in a A/C system need only account for 1²R losses, which may be negligible at the lengths of typical mowers or can be accounted for with increased diameter power cables.

Additionally, the ability to provide for a larger cutting width presents additional advantages. First, a larger width reduces the time necessary to cut a certain area in relation to a smaller width. This time reduction not only reduces the amount of time someone may be out in the sun, but also may reduce the total emissions necessary to cut a certain area.

Also, the weight of an electrical motor capable of imparting a torque similar to an internal combustion lawn motor is typically less. Thus, if desired, the assemblies may be readily removed for modularity as well as stored in an upright configuration when not in use. Because the assemblies may be readily stored upright, the cutting blade attached to a particular rotor may be more easily changed or re-sharpened.

Further, because the assemblies typically use an off-the-shelf electrical power generator, an economical advantage may be found. The generator may be removed and used for other purposes such as powering a home or electrical tools. A generator may be used to help a homeowner with an often occurring duty instead of staying in storage in the off chance that an electrical power failure may occur.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, these embodiments are not limited to the specific methods and instrumentalities disclosed. In the drawings:

FIG. 1 is an exemplary and non-limiting front view of a lawn mower;

FIG. 2 is an exemplary and non-limiting front view of the constituent components of a lawn mower;

FIG. 3 is an exemplary and non-limiting front view of a lawn mower attachment; and

FIG. 4 is an exemplary and non-limiting top view of a lawn mower attachment.

### DETAILED DESCRIPTION

The subject matter of the described embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. Further, for purposes of explaining the present subject matter, components that may be similar in function but are mirror images of each other have been numbered with the same number.

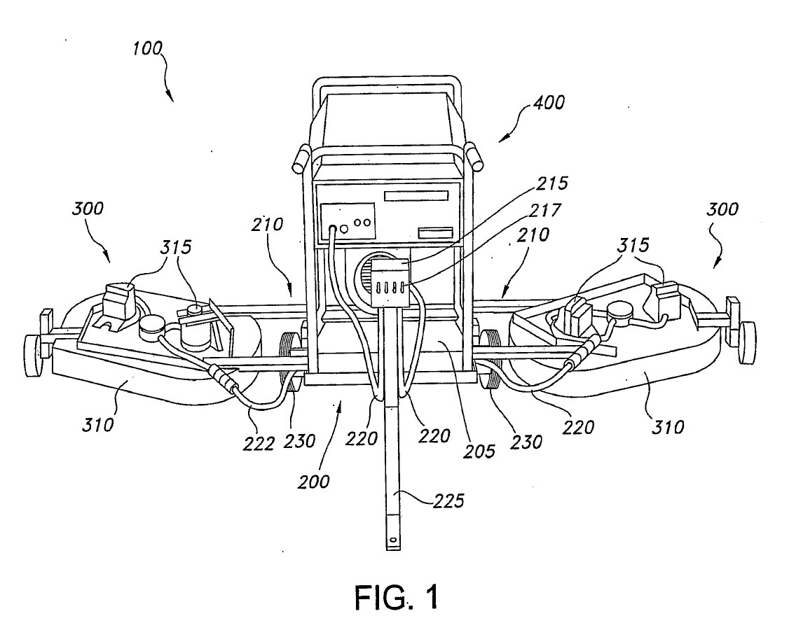

Referring to the drawings wherein like reference numerals designate corresponding parts throughout the several figures, reference is made first to FIG. 1. FIG. 1 illustrates a front view of an exemplary and non-limiting example of lawn mower blade assembly, or attachment, 100. In general, attachment 100 includes carrier trailer 200, which generally includes platform 205 having mower assembly attachment sections 210. In a typical implementation, the carrier functions as a central base for receiving external power generator 400. Mower assembly sections 210 are for receiving mower assemblies 300, discussed below. Trailer 200 further typically includes tow bar 225 for attachment to a carrier vehicle, discussed below. Trailer 200 further typically includes wheels 230 for mobility.

Electrical power, preferably AC power, is controlled through switch box 215 having switches 217. Various functions may be performed by switches 217, though the main function is to either energize or remove power from power cables 220, which transfer power to electrical motors 315, causing the rotor of motors 315 to rotate when energized. The rotation of motors 315 rotor is imparted to blades situated within assembly 300 housing 310.

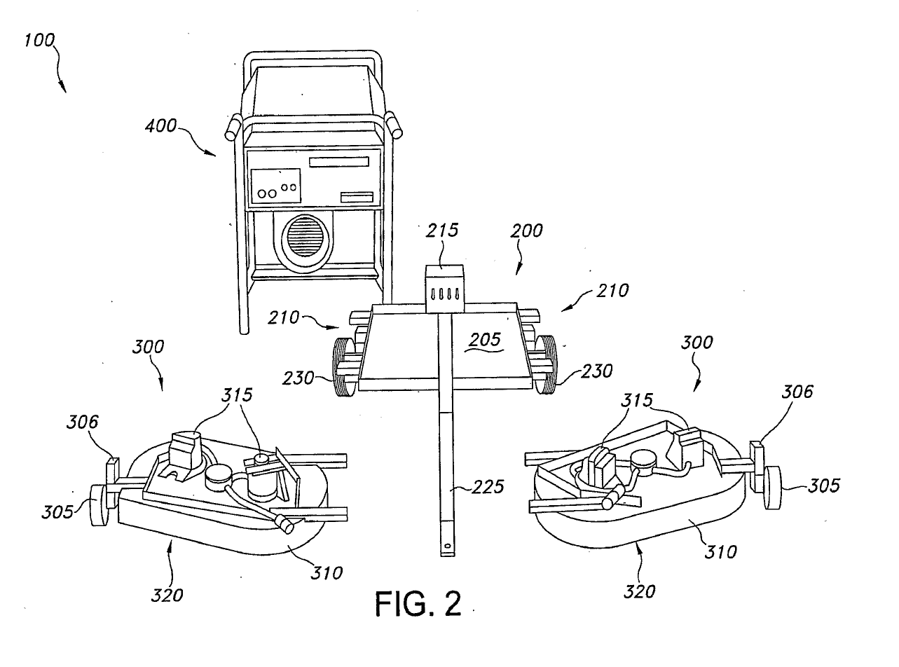

FIG. 2 illustrates a front view of the various components of a preferable example of lawn mower attachment system 100. FIG. 2 illustrates how the components of system 100 allow for a degree of modularity and interoperability as well as compactness of system 100. FIG. 2 further illustrates how system 100 can advantageously be implemented as a lawn mower attachment kit. In general, similar to as discussed in the description above, lawn mower system 100 typically includes lawn mower attachment trailer 200, generally including trailer platform 205, first and second mower deck attachment sections 210. Switch box 215, to connect and disconnect power to the electrical drive components, is disposed adjacent to platform 205 and tow bar 225.

System 100 typically further includes first and second blade decks 300 for disposition on mower deck attachment sections 210. Blade decks 300 typically further include wheels 305, which are height adjustable via height adjusters 306. Typically, blade decks 300 generally include housing 310, at least on motor 315 disposed on housing 310, and lawn mower blade 320 coupled to motor 315. Additional motors can be advantageously added to individual blade decks 300 as required or desired. In general, it is appreciated that each of motors 315 independently receive power from external power generator 400, via switch box 215, which can be selectively engaged to supply power to the desired motors 315. In another example, decks 300 can further include lights 340 generally disposed on housing 310 and receiving power from external power generator 400.

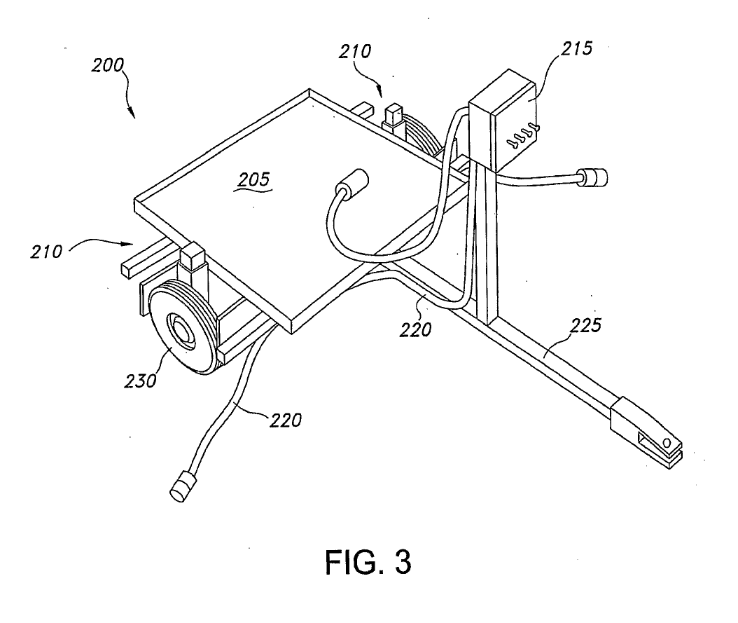

FIG. 3 illustrates further an example of trailer 200. Typically, trailer 200 further includes a power regulator, which is typically in the form of a switch box that is electrically coupled to external power generator 400. Several wires 200 operate as conduits for transferring power from external power generator 400 to power regulator 215, and ultimately to mower assemblies 300.

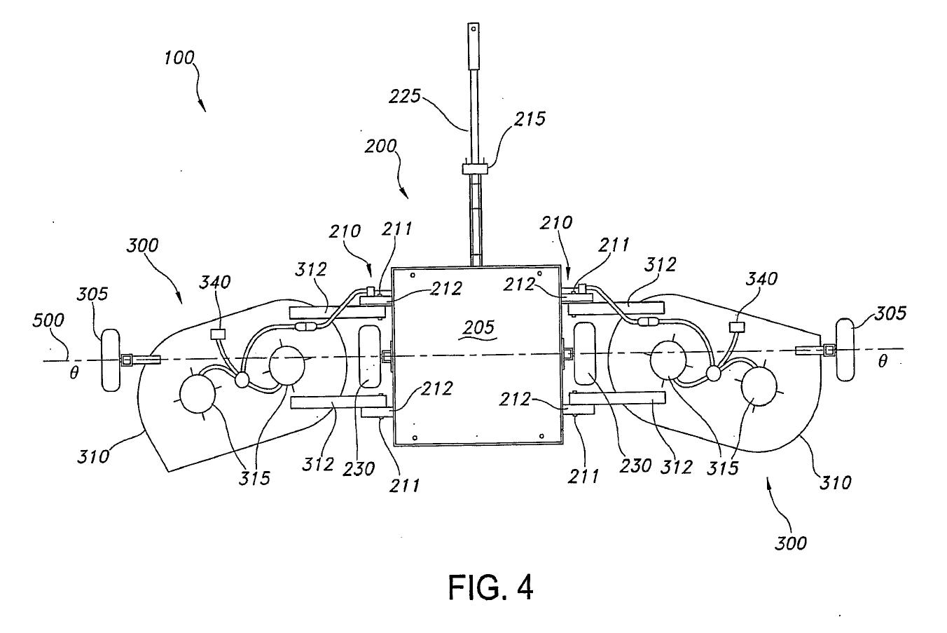

In general, it is further appreciated that blade decks 300 are pivotally connected to the attachment sections 210, via pivot points 211 as better illustrated in FIG. 4. Blade decks 300 are generally positionable into a first open position generally co-planar and parallel to trailer platform 205, and a second closed position generally perpendicular to trailer platform 205. In one example, trailer 200 further includes arms 212, pivotally connected to deck arms 312 thereby allowing the pivotal connection between trailer 200 and blade decks 300. In another example, all wheels 230, 305 are aligned along a common axis 500. Furthermore, blade decks 300 are rotated slightly rearward of system 100, and at an angle Θ with respect to axis 500. This advantageous orientation allows for overlap of blades 320 when mowing a wide area. Such an overlapping relationship is used to prevent remaining growth in a mowed area.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is claimed:

1. A lawn mower apparatus comprising:
a central base for receiving an external power generator; and
a first mower assembly attachment section, wherein the section comprises a blade, wherein the blade is rotated by an electric motor.

2. The apparatus of claim 1, wherein the central base further comprises a power regulator.

3. The apparatus of claim 2, further comprising a first conduit for transferring power from the power regulator to the first mower assembly attachment section.

4. The apparatus of claim 2, further comprising a second mower assembly attachment section.

5. The apparatus of claim 4, further comprising a second conduit for transferring power from the power regulator to the second mower assembly attachment section.

6. The apparatus of claim 4, further comprising a third mower assembly attachment section.

7. The apparatus of claim 6, further comprising a third conduit for transferring power from the power regulator to the third mower assembly attachment section.

8. The apparatus of claim 2, wherein the power regulator is configured to receive power from the external power generator and to distribute power to the first assembly attachment section.

9. The apparatus of claim 1, wherein the electric motor is a direct current motor.

10. The apparatus of claim 1, wherein the electric motor is an alternating current motor.

11. The apparatus of claim 1 further comprising a tow bar connected to the central base.

12. A lawn mower system, comprising:
a lawn mower attachment trailer, wherein the trailer comprises a trailer platform and a first mower deck attachment section; and
a first blade deck connected to the first mower deck attachment section, wherein the first blade deck comprises:
a housing;
at least one motor disposed on the housing; and
a lawnmower blade coupled to the motor.

13. The system of claim 12, further comprising:
a second blade deck disposed on the first mower deck attachment section.

14. The system of claim 12, further comprising an external power generator disposed on the trailer platform.

15. The system of claim 12, wherein the trailer platform further comprises a switch box.

16. The system of claim 15, wherein external power generator is electrically coupled to the switch box.

17. The system of claim 15, wherein the switch box is for distributing power to the first blade deck.

18. The system of claim 12, wherein the first blade deck is pivotally connected to the attachment section.

19. The system of claim 18, wherein the first blade deck is positionable into a first open position generally co-planar and parallel to the trailer deck, and a second closed position generally perpendicular to the trailer deck.

20. A lawn mowing system, comprising:
a pulling vehicle having a motor;
a lawn mower trailer coupled to the pulling vehicle;
a power generator discrete from the tractor mower, the power generator being removably positioned upon the lawn mower trailer;
at least one blade assembly disposed on the lawn mower trailer, the blade assembly receiving power from the power generator; and
means for selectively supplying power from the power generator to the at least one blade assembly.
